(19) United States
(12) Patent Application Publication
(10) Pub. No.: US 2007/0052912 A1
(43) Pub. Date: Mar. 8, 2007

(54) Liquid crystal display device

(75) Inventors: Yasushi Kawata, Ageo-shi (JP); Akio Murayama, Fukaya-shi (JP); Kisako Ninomiya, Fukaya-shi (JP); Norihiro Yoshida, Fukaya-shi (JP); Chigusa Tago, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/503,960

(22) Filed: Aug. 15, 2006

(30) Foreign Application Priority Data
Sep. 6, 2005 (JP) 2005-258226

(51) Int. Cl. G02F 1/1333

(52) U.S. Cl. 349/158

(57) ABSTRACT

Transmission display regions are disposed at both sides of a reflection display region of a pixel electrode in a pixel of an array substrate. An insulating layer having a first insulating layer and a second insulating layer that face the transmission display regions and the reflection display region in the pixel electrode is formed on the counter electrode of the counter substrate. Second insulating layers exist at both sides of the first insulating layer. The motion of liquid crystal molecules is symmetrical with respect to the reflection display region. Liquid crystal orientation stability can be enhanced at a plurality of pixels. A defect such as unevenness in display due to orientation fluctuation of the liquid crystal molecules in the liquid crystal layer can be avoided. A liquid crystal cell having a high display quality level is provided.

### INCORPORATION BY REFERENCE

The present application claims priority under 35 U.S.C. §119 to Japanese Patent Application No. 2005-258226 filed on Sep. 6, 2005. The content of the application is incorporated herein by reference in its entirety.

### FIELD OF THE INVENTION

The present invention relates to a liquid crystal display device having a liquid crystal layer interposed between an array substrate and a counter substrate.

### BACKGROUND OF THE INVENTION

This type of liquid crystal display device is characterized by lightness in weight, thin design and low power consumption, and thus it is applied to various fields such as OA (Office Automation) equipment, an information terminal device, a clock, a television set, etc. In particular, liquid crystal display devices using TFT (Thin Film Transistor) elements out of liquid crystal display devices are used in many display devices for cellular phones, television sets, computers, etc., because the TFT element has excellent response.

Recently, display devices having high resolution and broad field-of-view angles have been demanded in connection with the compact and light design of information terminal devices. In order to enhance the high resolution, the structure of the array substrate provided with TFT elements is made minute. With respect to the field-of-view angle, there has been proposed a display device having a liquid crystal mode of a broad field-of-view angle which uses an OCB (Optically Compensated Bend) system using nematic liquid crystal, an MVA (Multi-domain Vertical Alignment) system or an IPS (In-Plane Switching: transverse electric field) system.

Furthermore, the frequency of use outdoors has been recently increased, and thus there has been practically used a semi-transmission type liquid crystal display system having a liquid crystal mode in which a semi-transmission display having a reflection display system capable of displaying based on partially reflected light can be performed in addition to a transparent display system capable of displaying based on transmitted light. Accordingly, there has been strong demand for producing a high-performance liquid crystal display device having a broad field-of-view and an excellent visibility out of doors by combining the liquid crystal mode based on the broad field-of-view and the liquid crystal mode for enabling semi-transmission display.

In particular, in the semi-transmission type liquid crystal display device in which both transparent display and reflection display can be performed, it is required to control the thickness of the liquid crystal layer in each of the transparent region for which transparent display is possible and the reflection region for which reflection display is possible independently of each other. In general, a convex-shaped projecting portion is provided below a counter electrode that is disposed so as to face the reflection region and applies a voltage to the liquid crystal layer between the array substrate and the counter substrate faced to the array substrate, and the thickness of the liquid crystal layer in the reflection region is controlled. Therefore, the process of forming the projecting portion must be increased.

Therefore, the construction of a liquid crystal display device of an MVA system in which orientation is divided by a dielectric structure of resist material is disclosed and known by Japanese Laid-Open Patent Publication No. 2003-107508. In this Japanese Laid-Open Patent Publication No. 2003-107508, a dielectric layer is also formed in a reflection region by using a dielectric layer for dividing the orientation, and retardation of the liquid crystal layer is controlled by voltage drop, whereby the apparent thickness of the liquid crystal layer in the reflection region is reduced.

However, in the liquid crystal display device of the MVA system described in Japanese Laid-Open Patent Publication No. 2003-107508, it is required that an orientation-controlling convex-shaped dielectric layer inherent to the MVA system and a convex-shaped dielectric layer for adjusting the thickness of the liquid crystal layer in the reflection region are formed independently at the upper and lower sides of the pixel electrodes of the array substrate. Accordingly, the number of processes for producing the liquid crystal display device or the number of masks is increased, and also the number of the items for management such as control of film thickness, etc., is increased. Therefore, it is not easy to enhance the stability of the orientation of liquid crystal in the pixels and it is not easy to avoid defects such as irregularity in display, etc. Therefore, there is a problem that it is not easy to enhance display quality.

The present invention has been implemented in view of such a point, and has an object to provide a liquid crystal display device having excellent display quality.

### SUMMARY OF THE INVENTION

According to the present invention, a liquid crystal display device includes an array substrate having a translucent substrate, a plurality of pixels arranged in a matrix form on one principal surface of the translucent substrate, a reflection region that is provided for each of a plurality of pixels and made visible by light reflection, and transmission regions that are provided at both sides of the reflection region so as to sandwich the reflection region therebetween and made visible by light transmission; a counter substrate having a translucent substrate disposed so as to face the one principal surface of the translucent substrate of the array substrate, and an insulating layer provided on one principal surface of the translucent substrate at the side facing the one principal surface of the array substrate so as to face at least a part of each of the transmission regions and the reflection regions of a plurality of pixels; and a liquid crystal layer interposed between the array substrate and the counter substrate.

The transmission regions are provided at both sides of the reflection region in each of a plurality of pixels provided in a matrix form on one principal surface of the translucent substrate of the array substrate so as to sandwich the reflection region, and an insulating layer is provided on one side surface of the translucent substrate of the counter substrate which faces one principal surface of the array substrate so that the insulating layer faces at least a part of each of the transmission regions and the reflection regions of a plurality of pixels.

As a result, the motion of the liquid crystal layer to be controlled by the insulating layer of the reflection region is made symmetrical by the transmission regions located at both sides of the reflection region. Therefore, the orientation stability in each pixel can be enhanced, and the display unevenness caused by orientation fluctuation and the symmetry of the field-of-view angle can be secured, so that the display quality level can be enhanced.

### BRIEF DESCRIPTION OF THE DRAWINGS

FIG. 1 is a cross-sectional view showing a part of a first embodiment of a liquid crystal display device according to the present invention.

FIG. 2 is a plan view-showing a part of an array substrate of the liquid crystal display device.

FIG. 3 is a plan view showing a part of a counter substrate of the liquid crystal display device of the present invention.

FIG. 4 is a graph showing a CR field-of-view angle of the liquid crystal display device of the present invention.

FIG. 5 is a cross-sectional view showing a part of a second embodiment of the liquid crystal display device of the present invention.

FIG. 6 is a plan view showing a part of a counter substrate of the liquid crystal display device of the present invention.

FIG. 7 is a cross-sectional view showing a part of a liquid crystal display device of a first comparative example.

FIG. 8 is a plan view showing a part of an array substrate of the liquid crystal display device of the first comparative example.

FIG. 9 is a plan view showing a part of a counter substrate of the liquid crystal display device of the first comparative example.

FIG. 10 is a graph showing a CR field-of-view angle of the liquid crystal display device of the first comparative example.

FIG. 11 is an explanatory cross-sectional view showing a part of a liquid crystal display device of a second comparative example.

FIG. 12 is an explanatory plan view showing a part of a counter substrate of the liquid crystal display device of the second comparative example.

### DETAILED DESCRIPTION OF THE PREFFERED EMBODIMENT

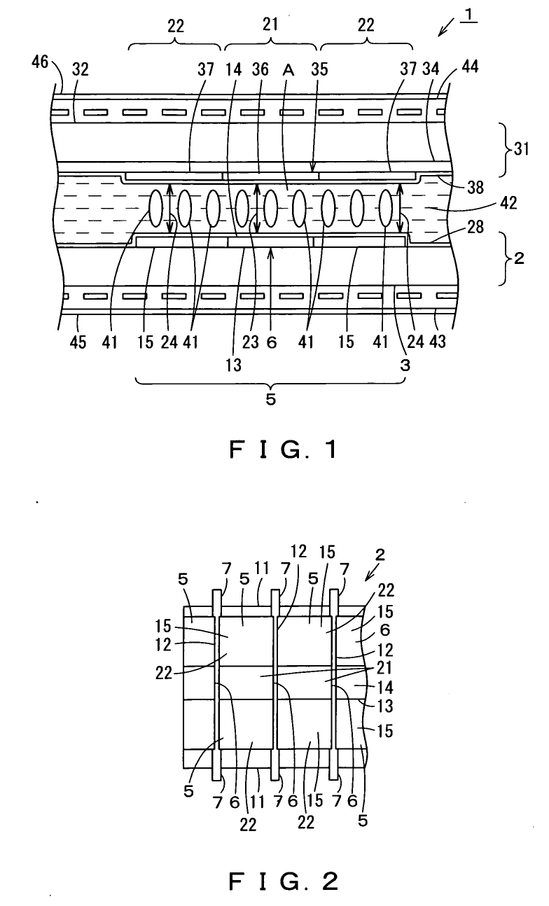

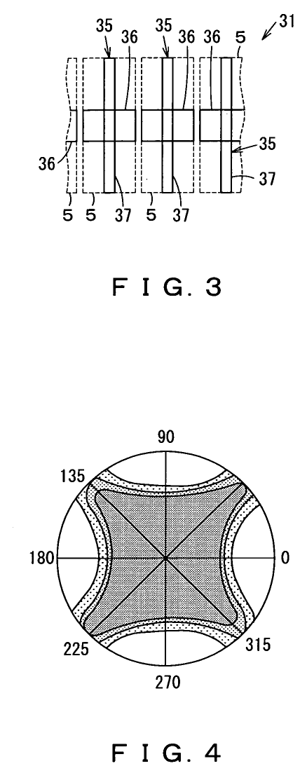

The construction of a first embodiment of a liquid crystal display device according to the present invention will be described with reference to FIG. 1 to FIG. 3.

In FIG. 1 to FIG. 3, reference numeral 1 denotes a liquid crystal cell as a liquid crystal display device, and the liquid crystal cell 1 is a semi-transmission type liquid crystal display element that has a broad field-of-view angle and includes a reflection display portion and a transparent display portion. Furthermore, the liquid crystal cell 1 is a display device having a vertical orientation type liquid crystal mode using a broad field-of-view angle mode called an MVA (Multi-domain Vertical Alignment) system.

The liquid crystal cell 1 has a substantially rectangular plate-like array substrate 2. The array substrate 2 has a substantially transparent rectangular plate-like glass substrate 3. The glass substrate 3 is a translucent substrate as a transparent substrate having translucency and electrical insulation. A plurality of pixels 5 are disposed in a matrix form on the surface as one principal surface of the glass substrate 3. Each of a plurality of pixels 5 is formed to have a slender and rectangular shape in a plan view which extends in the longitudinal direction of the glass substrate 3. Furthermore, each of a plurality of pixels 5 includes a pixel electrode 6, an auxiliary capacitor (not shown) corresponding to a pixel auxiliary capacitor as an accumulating capacitor, and a thin film transistor (TFT) 7 which are arranged one by one as a pixel constituent element.

Furthermore, a plurality of scan lines 11 as first wires are arranged along the width direction of the glass substrate 3 on the glass substrate 3. These scanning lines 11 are gate electrodes formed of electrically conductive film, and spaced from one another at equal intervals parallel in the lateral direction of the glass substrate 3. Furthermore, a plurality of signal lines 12 as second wires are arranged along the longitudinal direction of the glass substrate 3 on the glass substrate 3. These signal lines 12 are image signal wires as electrode wires formed of electrically conductive film, and spaced from one another at equal intervals parallel in the lateral direction of the glass substrate 3. The scan lines 11 and the signal lines 12 are formed by forming electrically conductive film according to the sputtering method or the like and then patterning it.

Furthermore, the scan lines 11 and the signal lines 12 are arranged so as to orthogonally cross one another on the glass substrate 3 and wired in a lattice shape. Each pixel 5 is provided in each rectangular shape surrounded by the scan line 11 and the signal line 12. Furthermore, the pixel electrode 6, the auxiliary capacitor and the thin film transistor 7 are provided for every pixel 5 in connection with each cross point between the scan line 11 and the signal line 12.

Furthermore, auxiliary capacitor (Cs) lines 13 as capacitance lines corresponding to a plurality of metal electrodes extending along the longitudinal direction of the scan lines 11 are disposed between the scan lines 11 on the glass substrate 3 along the width direction of the glass substrate 3. These auxiliary capacitance lines 13 are provided substantially at the center portion between the scan lines 11 along the longitudinal direction of the glass substrate 3 so as to be spaced from one another parallel to the scan lines 11. Furthermore, the auxiliary capacitance lines 13 are electrically connected to the auxiliary capacitors provided in the respective pixels 5. Each auxiliary capacitance line 13 constitutes a part of the pixel electrode 6 provided in each pixel 5. Still furthermore, a reflection face 14 for reflecting light incident to the surface of the auxiliary capacitance line 13 is formed on the surface corresponding to one principal surface of the auxiliary capacitance line 13.

The pixel electrode 6 in each pixel 5 is provided in a rectangular region partitioned by a plurality of scan lines 11 and signal lines 12. Transparent electrodes 15 are laminated at both the side portions of the auxiliary capacitance line 13 of the pixel electrode 6 so as to be continuous with the auxiliary capacitance line 13. These transparent electrodes 15 are transmissible pixel electrodes formed of transparent ITO (Indium Tin Oxide), for example, and they cover the regions between the signal lines 12 at both sides of the auxiliary capacitance line 13 in each pixel 5. Accordingly, these transparent electrodes 15 are provided at both the side portions by which the auxiliary capacitance line 13 in each pixel 5 is sandwiched, and laminated in the same layer as the auxiliary capacitance line 13.

Here, the region where the auxiliary capacitance line 13 in each pixel 5 is laminated serves as a reflection display region 21 as a reflection region in which display based on the reflection system is possible and thus viewing is possible by light reflection. Furthermore, the region where the transparent electrode 15 in each pixel 5 is laminated serves as a transmission display region 22 as a transmissible region in which display based on the transmission system is possible and thus viewing is possible by light transmission. Accordingly, in each pixel 5, the reflection display region 21 is disposed like a rectangular flat plate at the center portion in the longitudinal direction of the pixel electrode 6 of each pixel 5 over the whole width direction of each pixel 5. Furthermore, cell gaps 23 and 24 in the reflection display region 21 and the transmission display regions 22 are uniformly formed because the transparent electrodes 15 of the pixel electrode 6 and the auxiliary capacitance line 13 are uniformly formed on the same plane.

Furthermore, the transmission display regions 22 are provided at both sides along the longitudinal direction of the pixel electrode 6 of the reflection display region 21 in each pixel 5 so as to be disposed like a rectangular flat plate over the whole width direction of each pixel 5. Therefore, the transmission display regions 22 are provided symmetrically, that is, linearly symmetrically at both sides of the reflection display region 21 in each pixel 5. Furthermore, the reflection display region 21 and the transmission display regions 22 are formed so that the relationship between the voltage applied to each of the reflection display region 21 and the transmission display regions 22 and the brightness characteristic, that is, the applied voltage-brightness characteristic is substantially coincident among these regions.

Orientation film 28 formed by an orientation treatment of polyimide, for example, is laminated on the glass substrate 3 containing each pixel electrode 6. This orientation film 28 is formed by conducting orientation means on the surface of the glass substrate 3 covering the pixel electrode 6. The orientation film 28 is an orientation treated layer formed by coating a vertical orientation film at a thickness which is not less than 70 nm and not more than 90 nm, for example. The orientation film 28 is subjected to the orientation treatment in a fixed direction and covers each of the pixel electrode 6 of each pixel 5, the thin film transistor 7, the scan line 11, the signal line 12 and the auxiliary capacitance line 13 in each pixel 5.

A counter substrate 31 having a rectangular flat-plate shape as a common substrate is disposed so as to face the array substrate 2. The counter substrate 31 is equipped with a glass substrate 32 having a substantially transparent rectangular flat-plate shape. The glass substrate 32 is a translucent substrate as a transparent substrate having translucency and electrical insulation. A counter electrode 34 as a common electrode formed of ITO is laminated on the surface corresponding to one principal surface of the glass substrate 32 which faces the array substrate 2.

An insulating layer 35 having a convex-shaped convex structure projecting from the surface of the counter electrode 34 is disposed on the counter electrode 34. The insulating layer 35 has an insulating structure, and is formed of a photosensitive acrylic resist. Furthermore, the insulating layer 35 is formed to have a thickness of about 1.5 μm±0.2 μm, for example. When the counter substrate 31 is faced to the array substrate 2, the insulating layer 35 is provided substantially in a lattice form so as to face at least a part of each of the reflection display region 21 and the transmission display regions 22 of pixel electrode 6 in each pixel 5 of the array substrate 2. When the counter substrate 31 is faced to the array substrate 2, the insulating layer 35 is equipped with a plurality of convex-shaped first insulating layers 36 facing the auxiliary capacitance lines 13 of the array substrate 2.

Concretely, the first insulating layer 36 is a reflection region insulating layer as a reflection portion convex-shaped structure provided so as to face the reflection display region 21 in each pixel 5 of the array substrate 2. That is, the first insulating layer 36 is provided so as to be overlapped with the reflection display region 21 of the array substrate 2, and disposed along the lateral direction of the glass substrate 32 of the counter substrate 31. Accordingly, the first insulating layer 36 is formed in a rectangular shape in a plan view which is equal to a part of the auxiliary capacitance line 13 located in each pixel 5 of the array substrate 2. Furthermore, the first insulating layer 36 is provided for MVA orientation control and is formed to have a substantially fixed film thickness.

The first insulating layer 36 has a longitudinal direction along the longitudinal direction of the auxiliary capacitance line 13 on the array substrate 2, and a width dimension equal to the width dimension of the auxiliary capacitance line 13. The first insulating layer 36 is formed to have a slender rectangular shape in a plan view, the slender rectangular shape having a longitudinal dimension equal to the width dimension in each pixel 5 of the array substrate 2. The first insulating layer 36 is disposed so that the edge shape of the peripheral portion as the fringe portion of the first insulating layer 36 is symmetrical with respect to the center in the longitudinal direction of the insulating layer 35.

Here, the edge shape of the peripheral portion as the fringe portion of the pixel electrode 6 in each pixel 5 of the array substrate 2 is also symmetrical with respect to the center in the longitudinal direction of the insulating layer 35. Here, a resist material which can be treated in the production process of the existing array substrate 2 may be used as the first insulating later 36. In particular, it is preferable that a material used for a second insulating layer 37 for orientation control of MVA is used as the first insulating layer 36.

Furthermore, a plurality of convex-shaped second insulating layers 37 disposed along the longitudinal direction of the glass substrate 32 of the counter substrate 31 are laminated on the counter electrode 34. The second insulating layer 37 is a transmission region insulating layer as a transmission portion convex-shaped structure provided so as to face the transmission display region 22 in each pixel 5 of the array substrate 2. The second insulating layer 37 is provided in the same layer as the first insulating layer 36, and it is formed of the same material, in the same step, that is, in the same process as the first insulating layer 36 at the same time.

That is, the second insulating layers 37 are provided at both sides of the first insulating layer 36. The second insulating layers 37 are provided so as to be overlapped with and faced to the transmission display regions 22 of the array substrate 2, when the counter substrate 31 is faced to the array substrate 2. Accordingly, the second insulating layers 37 are formed along the longitudinal direction of the array substrate 2 so as to be located at the center portion in the width direction between the signal lines 12 of the array substrate 2.

Accordingly, the second insulating layers 37 are laminated on the counter electrode 34 of the counter substrate 31 at the same pitch as the width dimension between the signal lines 12 of the array substrate 2. The second insulating layer 37 is formed so as to have a longitudinal direction perpendicular to the longitudinal direction of the first insulating layer 36 and a slightly larger width dimension than the width dimension of the signal lines 12 of the array substrate 2.

Orientation film 38 formed by the orientation treatment of polyimide, for example, is laminated on the glass substrate 32 containing the insulating layers 35 each composed of the first insulating layer 36 and the second insulating layer 37 and the counter electrode 34. The orientation film 38 is formed by conducting orientation means on the surface of the glass substrate 32 covering the insulating layer 35 and the counter electrode 34. The orientation film 38 is an orientation treatment layer formed by coating vertical orientation film at a thickness which is not less than 70 nm and not more than 90 nm, for example. The orientation film 38 is subjected to the orientation treatment in a fixed direction, and covers the counter electrode 34 and the insulating layer 35 on the glass substrate 32.

Furthermore, the orientation film 38 and the orientation film 28 on the array substrate 2 are disposed so as to face each other and attached to each other by a seal member (not shown) so that a predetermined gap, for example, of 3.5 μm±0.3 μm is formed via a spacer (not shown) as an inter-substrate gap member between the orientation film 28 and the orientation film 38 and a liquid crystal sealing region A as a liquid crystal injection space is formed. Liquid crystal molecules 41 as a liquid crystal composition are sealingly injected in the liquid crystal sealing region A, and a liquid crystal layer 42 as an optical modulation layer is formed. Accordingly, the liquid crystal layer 42 is sandwiched and held between the orientation film 28 of the array substrate 2 and the orientation film 38 of the counter substrate 31. Here, the liquid crystal layer 42 which respectively faces the reflection display region 21 and the transmission display regions 22 in each pixel 5 of the array substrate 2 is supplied with a voltage via the counter electrode 34 facing the reflection display region 21 and the transmission display regions 22 of each pixel 5.

Liquid crystal material having negative conductive anisotropy (Nn), for example, is used as the liquid crystal molecules 41 of the liquid crystal layer 42. Accordingly, a vertical orientation type liquid crystal mode in which the liquid crystal molecules 41 are vertically oriented is provided as the liquid crystal cell 1. Furthermore, quarter wavelength plates 43 and 44 which are rectangular flat-plate shaped optical filters are laminated on and attached respectively to the back surfaces corresponding to the other principal surfaces of the respective glass substrates 3 and 32 of the array substrate 2 and the counter substrate 31 of the liquid crystal cell 1. Furthermore, linear polarization plates 45 and 46 as half wavelength plates are laminated on and attached to the quarter wavelength plates 43 and 44.

Here, a polarizing element generally called a circular polarization plate is used as the linear polarization plates 45 and 46 so that electro-optical switching can be effectively performed in the reflection display region 21 in each pixel 5 of the array substrate 2. A structure achieved by combining a linear polarization element with a quarter wavelength plate or a structure achieved by laminating a quarter wavelength plate and a half wavelength plate to suppress transmittance conversion of light by a wavelength may be used as the circular polarization plate. Furthermore, these linearly polarization plates 45 and 46 may be added with an optical element having a negative phase difference from the viewpoint of broadening the field-of-view angle.

As a result, in the liquid crystal cell 1, the thin film transistor 7 of each pixel 5 is switched to apply a video signal to the pixel electrode 6 and control the orientation of the liquid crystal molecules 41 in the liquid crystal layer 42, whereby light reflected in the reflection display region 21 of the pixel electrode 6 in each pixel 5 and light transmitted through the transmission display regions 22 of the pixel electrode 6 are respectively modulated, thereby making a prescribed image visible.

Next, a method of producing the liquid crystal display device according to the first embodiment will be described.

First, the array substrate 2 on which the pixel electrodes 6 are arranged in a matrix form is prepared.

Furthermore, the insulating layer 35 is formed on the counter electrode 34 of the counter substrate 31 by using a photosensitive acrylic resist so as to face the pixel electrode 6 of the array substrate 2.

At this time, the region in the pixel electrode 6 on the array substrate 2, which faces the first insulating layer 36 of the counter substrate 31 facing the pixel electrode 6, is formed by a metal electrode from which light is reflected, thereby forming the auxiliary capacitance line 13. Furthermore, the region in the pixel electrode 6 on the array substrate 2, which faces the second insulating layer 37 of the counter substrate 31, is formed by the transparent electrode 15 through which light is transmitted.

Furthermore, the vertical orientation film is coated on the respective surfaces of the array substrate 2 and the counter substrate 31 which are brought into contact with the liquid crystal layer 42, thereby forming the orientation film 28 and 38.

Subsequently, the array substrate 2 and the counter substrate 31 are attached to each other via a space by a seal member while keeping the gap therebetween.

Thereafter, the liquid crystal molecules 41 are filled in the liquid crystal sealing region A between the array substrate 2 and the counter substrate 31 and sealed, thereby forming the liquid crystal layer 42.

Furthermore, the quarter wavelength plates 43 and 44 and the linear polarization plates 45 and 46 are disposed on the back surfaces of the array substrate 2 and the counter substrate 31, thereby forming the semi-transmission type liquid crystal cell 1 having the reflection display region 21 and the transmission display regions 22.

As a result, when checking the characteristic of the linear polarization state of the linear polarization plates 45 and 46 of the liquid crystal cell 1 from which the circular polarization plate was excluded, a CR (Computed Radiography) field-of-view angle having a symmetrical shape substantially in the vertical direction of the liquid crystal cell 1 could be confirmed, and also it could be checked that it has such quality that there is no unevenness in display such as rough deposits or the like as shown in FIG. 4.

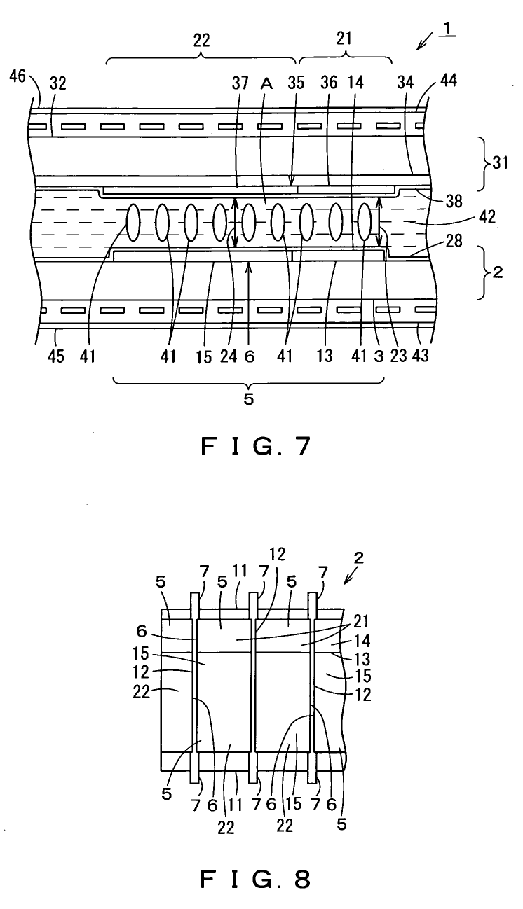

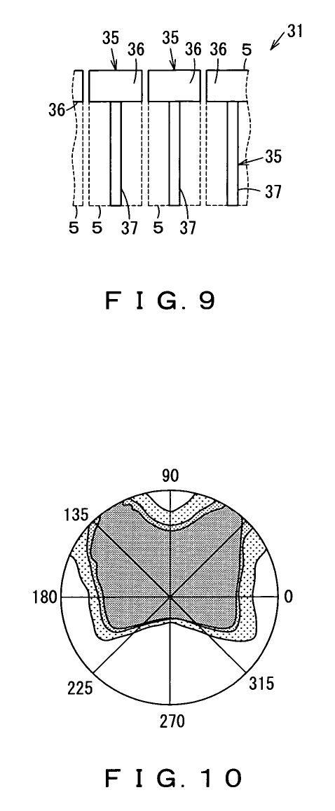

On the other hand, as shown in a first comparative example shown in FIG. 7 to FIG. 9, in the case of a liquid crystal cell 1 in which the auxiliary capacitance line 13 is wired at one end portion of the longitudinal direction of the pixel electrode 6 of the array substrate 2, and the first insulating layer 36 is formed at one end portion of the longitudinal direction of the insulating layer 35 so as to face the auxiliary capacitance line 13, when checking the characteristic of the linear polarization state of the linear polarization plates 45 and 46 of the liquid crystal cell 1 from which the circular polarization plate was excluded, as shown in FIG. 10, a CR field-of-view angle having an asymmetrical shape in the vertical direction of the liquid crystal cell 1 could be confirmed, and it could be checked that there occurs unevenness in display such as rough deposits or the like.

Here, in the conventional liquid crystal cell 1 in which the transmission display region 22 is disposed at only one end side or the other end side of the reflection display region 21 of the array substrate 2 in the longitudinal direction of the pixel 5, the motion of the liquid crystal molecules 41 to be controlled in the first insulating layer 36 facing the reflection display region 21 of the liquid crystal cell 1 and the peripheral edge portion of the pixel electrode 6 is asymmetrical in the pixel 5, and there easily occurs problems such as unevenness caused by orientation fluctuation, asymmetry of the field-of-view angle, etc.

Therefore, in the liquid crystal cell 1 of the first embodiment, as described above, the transmission display regions 22 are disposed at both sides of the reflection display region 21 of the pixel electrode 6 in each pixel 5 of the array substrate 2, and the insulating layer 35 having the first insulating layer 36 and the second insulating layers 37 which face the reflection display region 21 and the transmission display regions 22 respectively in each pixel 5 of the array substrate 2 is formed on the counter electrode 34 of the counter substrate 31.

As a result, the second insulating layers 37 exist at both sides of the first insulating layer 36. Therefore, with respect to the motion of the liquid crystal molecules 41 controlled at the first insulating layer 36 and the peripheral edge portion of the pixel electrode 6 in each pixel 5, the transmission display regions 22 disposed at both sides of the reflection display region 21 are symmetrical with each other with respect to the reflection display region 21.

Accordingly, the liquid crystal orientation stability can be enhanced in each of a plurality of pixels 5, and also the defects such as unevenness of display caused by orientation fluctuation of the liquid crystal molecules 41 in the liquid crystal layer 42 can be avoided, so that the asymmetry of the field-of-view angle can be avoided. Therefore, the symmetry of the field-of-view angle in each pixel 5 of the liquid crystal cell 1 can be secured, and the overall characteristic of the image quality of the liquid crystal cell 1 can be enhanced. Accordingly, the display quality level of the liquid crystal cell 1 can be enhanced, so that a semi-transmission type liquid crystal cell 1 having a broad field-of-view angle can be easily provided.

Furthermore, the vertical orientation type liquid crystal display system in which the liquid crystal molecules 41 having negative dielectric anisotropy are vertically oriented is used as the liquid crystal display mode of the liquid crystal cell 1, and in particular the broad field-of-view angle mode as the MVA system is adopted. Accordingly, by using the liquid crystal cell 1 having the liquid display mode of the vertical orientation type adopting the MVA system, the production step of the horizontal orientation type liquid crystal cell 1 represented by TN (Twist Nematic) type or IPS type which have been hitherto practically used, that is, the rubbing treatment of the production process can be emitted. Accordingly, an occurrence of dust in the rubbing treatment step and a defect such as unevenness in rubbing when the liquid crystal cell 1 is produced can be avoided. Therefore, the productivity of the liquid crystal cell 1 can be enhanced, and a semi-transmission type liquid crystal cell 1 having an excellent field-of-view angle characteristic can be produced with high yield.

Furthermore, according to the MVA system, the tilt direction of the liquid crystal molecules 41 in the liquid crystal layer 42 is controlled by the insulating layer 35 formed on the counter electrode 34 of the counter substrate 31 or the outer peripheral edge (fringe-field) as a notch portion of the counter electrode 34. Accordingly, by forming the second insulating layer 37 at both sides of the first insulating layer 36 of the counter substrate 31 described above, the tilt direction of the liquid crystal molecules 41 can be controlled by the second insulating layer 37 facing the transparent electrode 15 in each pixel 5 of the array substrate 2. At this time, the second insulating layer 37 is constructed by the pattern used for the photosensitive resist, whereby the tilt direction of the liquid crystal molecules 41 at the portion facing the transmission display region 22 in each pixel 5 of the array substrate 2 can be controlled to any direction.

Furthermore, it has been hitherto conventional that the thickness of the liquid crystal layer 42 in the reflection display region 21 of the array substrate 2 is controlled by the insulating layer on the counter substrate 31. However, in this case, it is required that the insulating layer for controlling the insulating layer for orientation control inherent to the MVA mode and the insulating layer for controlling the thickness of the liquid crystal layer 42 for reflection display are produced at both the upper and lower sides of the counter electrode 34 independently of each other. Accordingly, the number of processes and the number of masks when the liquid crystal cell 1 is produced are increased, and the number of management items such as the film thickness control of the insulating layer, etc., is increased, which causes reduction in yield.

On the other hand, in the reflection display region 21 of the liquid crystal cell 1 of the above-described first embodiment, the first insulating layer 36 is formed of the same material, during the same step and in the same layer as the second insulating layer 37 provided for MVA orientation control of the transmission display region 22. As a result, the cost-up caused by the increase in the number of processes and the increase in the number of masks when the liquid crystal cell 1 is produced, and the number of the management items such as the film thickness control of the first insulating layer 36 and the second insulating layer 37 to effectively controlling the thickness of the liquid crystal layer 42 can be reduced to the same level as the conventional liquid crystal cell 1 of the MVA system.

Furthermore, it is important that the motion of the liquid crystal molecules 41 at the first insulating layer 36 facing the reflection display region 21 of each pixel 5 of the liquid crystal cell 1 is matched with that at the peripheral edge portion of each pixel electrode 6 of the array substrate 2 of the liquid crystal cell 1. Accordingly, it is preferable that the shape of the peripheral edge portion of the pixel electrode 6 and the shape of the peripheral edge portion of the first insulating layer 36 are symmetrical with each other with respect to the center of the longitudinal direction of the insulating layer 35. That is, it is most preferable that the first insulating layer 36 is disposed at the center of the longitudinal direction of the insulating layer 35. In practice, the second insulating layers 37 may be disposed at both sides of the first insulating layer 36.

Furthermore, a photosensitive resist material or the like which can be treated in the production process of the existing array substrate 2 may be used as the material to form the first insulating layer 36. In particular, it is preferable that an orientation control material for the MVA system is used as the material for the first insulating layer 36 from the viewpoint of the orientation controllability and the voltage-temperature (V-T) characteristic control based on the voltage drop in the reflection display region 21. Furthermore, the first insulating layer 36 is preferably set to be substantially fixed in film thickness and have the same shape as the auxiliary capacitance line 13 in the pixel electrode 6 of each pixel 5. However, when it is required that the color reproduction of the liquid crystal cell 1 is coincident between the reflection display region 21 and the transmission display region 22 with high precision, it is preferable that the applied voltage-brightness characteristics of the reflection display region 21 and the transmission display region 22 are coincident with each other within ±100 mV.

Accordingly, the liquid crystal electro-optical characteristic of the reflection display region 21 that has been hitherto controlled by only one parameter of the thickness of the liquid crystal layer 42 can be controlled by three parameters; the voltage drop by the insulating layer 35 provided on the counter electrode 34 of the counter substrate 31 as a first parameter, the thickness of the liquid crystal layer 42 controlled by the insulating layer 35 as a second parameter and the tilt direction of the liquid crystal molecules 41 by the pattern of the insulating layer 35 as a third parameter.

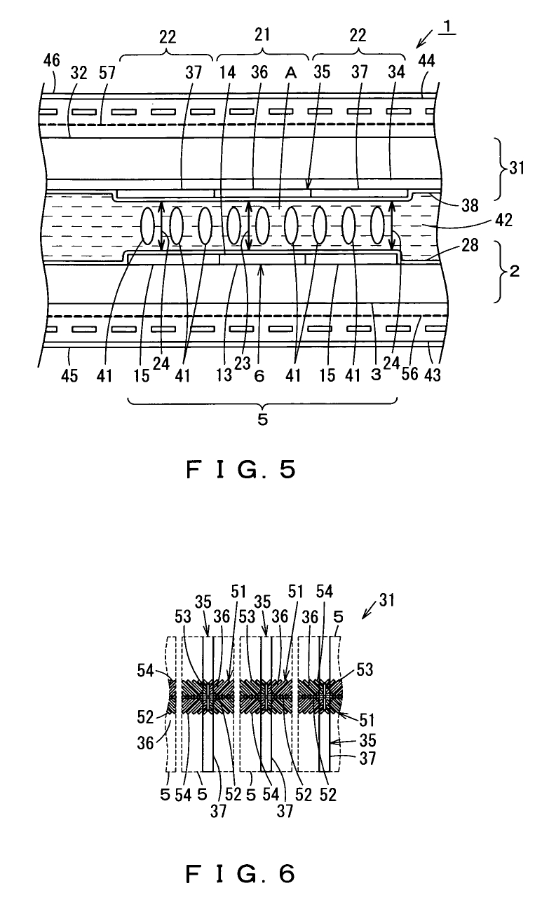

In the first embodiment, the first insulating layer 36 on the counter electrode 34 of the counter substrate 31 is formed to have a flat rectangular shape in a plan view which is substantially uniform in thickness. However, as in the case of a second embodiment shown in FIG. 5 and FIG. 6, the first insulating layer 36 may be formed to have an uneven shape in a plan view. The first insulating layer 36 is formed to have a substantially rectangular shape in a plan view, and a plurality of slender groove-shaped groove portions 51 are formed in the first insulating layer 36. These groove portions 51 are provided to control the voltage applied to the liquid crystal layer 42 and the tilt direction of the liquid crystal molecules 41, and for example, they are designed to have an uneven structure having a pitch of 8 μm±2 μm, for example. Concretely, these groove portions 51 have first groove portions 52 formed so as to extend from the center portion in the width direction of the first insulating layer 36 along the longitudinal direction of the first insulating layer 36. Furthermore, these groove portions 51 have second groove portions 53 formed so as to extend from the center portion in the longitudinal direction of the first insulating layer 36 along the width direction of the first insulating layer 36.

Furthermore, these groove portions 51 have third groove portions 54 formed by spacing the respective regions of the first insulating layer 36 achieved by partitioning the first insulating layer 36 into quarter parts, for example, by the first groove portion 52 and the second groove portion 53 parallel along the diagonal line connecting the end portions of the first groove portion 52 and the second groove portion 53. These third groove portions 54 have a longitudinal direction tilted to the longitudinal direction of each of the first groove portion 52 and the second groove portion 53 at an angle of about 45 degrees. Furthermore, the third groove portions 54 are formed so as to extend from the region of the first insulating layer 36 provided for the third groove portions 54 via the first groove portion 52 to a part of the region adjacent thereto. That is, the third groove portions 54 are formed so as to cross the first groove portions 52.

Furthermore, the half wavelength plates 56 and 57 are laminated between the quarter wavelength plates 43 and 44 and the linear polarization plates 45 and 46 on the back surfaces of the array substrate 2 and the counter substrate 31, respectively. As a result, when checking the characteristic of the linear polarization state of the linear polarization plates 45 and 46 of the liquid crystal cell 1 from which the circular polarization plate is excluded, as in the case of the first embodiment, a CR field-of-view angle having a symmetrical shape substantially in the vertical direction of the liquid crystal cell 1 can be confirmed, and it can be checked that the quality level is high with no unevenness in display such as rough deposits or the like. Therefore, the same action and effect as the first embodiment can be achieved.

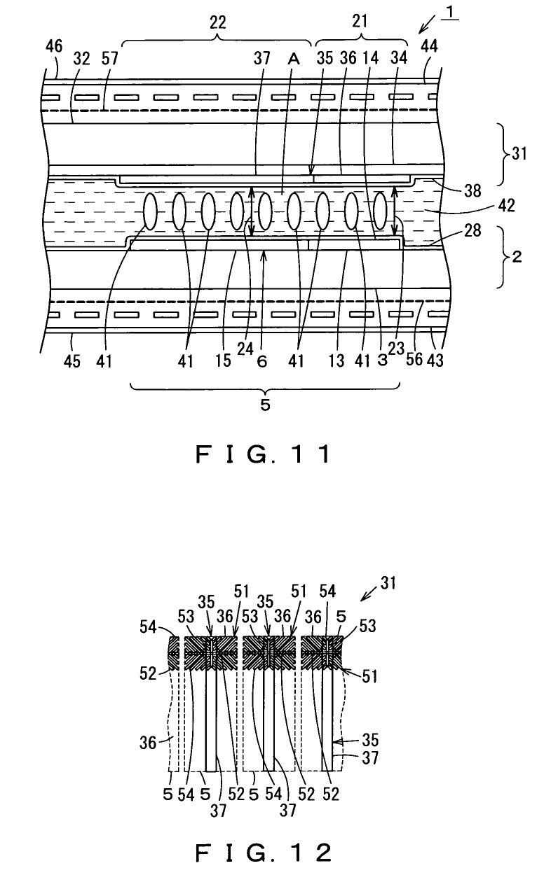

On the other hand, in the case of the liquid crystal cell 1 in which the auxiliary capacitance line 13 is wired to one end portion of the longitudinal direction of the pixel electrode 6 of the array substrate 2 and the uneven first insulating layer 36 is formed at one end portion of the longitudinal direction of the insulating layer 35 so as to face the auxiliary capacitance line 13 as in the case of a second comparative example shown in FIG. 11 and FIG. 12, when checking the characteristic of the linear polarization state of the linear polarization plates 45 and 46 of the liquid crystal cell 1 from which the circular polarization plate is excluded, a CR field-of-view angle having an asymmetrical shape in the vertical direction of the liquid crystal cell 1 can be confirmed as in the case of the first comparative example, and it can be checked that unevenness in display such as rough deposits or the like occurs.

Furthermore, in order to set the voltage applied to the portion of the liquid crystal layer 42 which faces the reflection display region 21 to a desired value, it has been hitherto conventional that the insulating layer 35 is embedded at the counter substrate 31 side to adjust the voltage. However, as in the case of the liquid crystal cell 1 of the second embodiment, the first insulating layer 36 is provided with the groove portions 51 to be designed in a minute uneven shape, thereby controlling the apparent thickness of the first insulating layer 36, and also the tilt direction corresponding to the polar angle of the liquid crystal molecules 41 and the in-plane direction corresponding to the azimuth of the liquid crystal molecules 41 can be simultaneously controlled. Here, from the viewpoint of enhancing the uniformity of orientation, it is preferable that the groove portions 51 of the first insulating layer 36 are formed at a minute cycle from not less than 3 μm to not more than 15 μm, for example. However, from the viewpoint of the balance among adjustment of the voltage applied to the liquid crystal layer 42, transmittance, image quality, etc., the cycle of these groove portions 51 may be set to be broader or narrower.

In the above-described embodiments, the pixel electrode 6 in each pixel 5 is controlled by the thin film transistor 7. However, the pixel electrode 6 may be controlled by a switching element other than the thin film transistor 7, such as Thin Film Diode (TFD) or the like, for example. Furthermore, a simple matrix type liquid crystal cell 1 other than the active matrix type liquid crystal cell 1 may be correspondingly used.

What is claimed is:

1. A liquid crystal display device comprising:
an array substrate having a translucent substrate, a plurality of pixels arranged in a matrix form on one principal surface of the translucent substrate, a reflection region that is provided for each of these pixels and made visible by light reflection, and transmission regions that are provided at both sides of the reflection region so as to sandwich the reflection region therebetween and made visible by light transmission;
a counter substrate having a translucent substrate disposed so as to face the one principal surface of the translucent substrate of the array substrate, and an insulating layer provided on one principal surface of the translucent substrate at the side facing the one principal surface of the array substrate so as to face at least a part of each of the transmission regions and the reflection regions of the pixels; and
a liquid crystal layer interposed between the array substrate and the counter substrate.

2. The liquid crystal display device according to claim 1, wherein the insulating layer is formed in an uneven shape.

3. The liquid crystal display device according to claim 1, wherein each of a plurality of pixels is provided in an elongated shape, the reflection region is provided at the center portion in the longitudinal direction of the pixel, and the transmission regions are provided at both sides of the reflection region along the longitudinal direction.

4. The liquid crystal display device according to claim 1, wherein the reflection region and the transmission regions are designed so that applied voltages and brightness are equal between the reflection region and the transmission regions.

5. The liquid crystal display device according to claim 1, wherein the array substrate is equipped with capacitance lines provided on one principal surface of the translucent substrate, and the insulating layer is provided so as to face the capacitance lines.

6. The liquid crystal display device according to claim 1, wherein a portion of the insulating layer that faces the reflection region and portions of the insulating layer that face the transmission regions are formed of the same material in the same step.

7. The liquid crystal display device according to claim 1, wherein in each pixel, the transmission regions are linearly symmetrically provided at both sides of the reflection region.

8. The liquid crystal display device according to claim 1, wherein the insulating layer is constructed by an acrylic resin having photosensitivity.

9. The liquid crystal display device according to claim 1, wherein the insulating layer comprises a reflection region insulating layer facing the reflection region and transmission region insulating layers facing the transmission regions provided at both sides of the reflection region insulating layer.

10. The liquid crystal display device according to claim 9, wherein the liquid crystal layer has liquid crystal molecules, and the reflection region insulating layer has groove portions for controlling the voltage applied to the liquid crystal layer and the tilt direction of the liquid crystal molecules.
